(19) United States
(12) Patent Application Publication
(10) Pub. No.: US 2005/0086056 A1
(43) Pub. Date: Apr. 21, 2005

(54) Voice recognition system and program

(75) Inventors: Akira Yoda, Kanagawa (JP); Shuji Ono, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/949,187

(22) Filed: Sep. 27, 2004

(30) Foreign Application Priority Data
Sep. 25, 2003 (JP) 2003-334274
Sep. 2, 2004 (JP) 2004-255455

(51) Int. Cl. G10L 15/00

(52) U.S. Cl. 704/246

(57) ABSTRACT

The present invention aims to improve precision of voice recognition without a troublesome operation. Thus, the present invention provides a voice recognition system including: a dictionary storage unit for storing a dictionary for voice recognition for every user; an imaging unit for imaging a user; a user identification unit for identifying the user by using the image captured by the imaging unit; a dictionary selection unit for selecting from the dictionary storage unit a dictionary for voice recognition for the user identified by the user identification unit; and a voice recognition unit for performing voice recognition for a voice of the user by using the dictionary for voice recognition selected by the dictionary selection unit.

This patent application claims priority from Japanese patent applications Nos. 2004-255455 filed on Sep. 2, 2004, and 2003-334274 filed on Sep. 25, 2003, the contents of which are incorporated herein by reference.

### BACKGROUND OF THE INVENTION

1. Field of the Invention

The present invention relates to a voice recognition system and a program. More particularly, the present invention relates to a voice recognition system and a program that change setting of the voice recognition system depending on a user so as to improve the precision of voice recognition.

2. Description of the Related Art

In recent years, voice recognition techniques for recognizing a voice and converting it into text data have developed. By using those techniques, a person who is not good at a keyboard operation can input text data into a computer. The voice recognition techniques can be applied to various fields and are used in a home electric appliance that can be operated by voice, a dictation apparatus that can write a voice as a text, or a car navigation system that can be operated without using a hand even when a user drives a car, for example.

The inventors of the present invention found no publication describing the related art. Thus, the description of such a publication is omitted.

However, since different users have different voices, for a certain user, the precision of recognition is low and the voice recognition cannot be practically used. Thus, a technique has been proposed which sets a dictionary for voice recognition in accordance with characteristics of a user so as to increase the precision of the recognition. However, according to this technique, although the recognition precision was increased, it was necessary for the user to input information indicating the change of the user by a keyboard operation or the like every time the user was changed. This input was troublesome.

### SUMMARY OF THE INVENTION

Therefore, it is an object of the present invention to provide a voice recognition system and a program, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a voice recognition system comprises: a dictionary storage unit operable to store a dictionary for voice recognition for every user; an imaging unit operable to capture an image of a user; a user identification unit operable to identify the user by using an image captured by the imaging unit; a dictionary selection unit operable to select a dictionary for voice recognition for the user identified by the user identification unit from the dictionary storage unit; and a voice recognition unit operable to perform voice recognition for a voice of the user by using the dictionary for voice recognition selected by the dictionary selection unit.

The imaging unit may further image a movable range of the user, the voice recognition system may further comprises: a destination detection unit operable to detect destination of the user based on the image of the user and an image of the movable range that were taken by the imaging unit; and a sound-collecting direction detection unit operable to detect a direction from which the voice was collected, and the dictionary selection unit may select the dictionary for voice recognition for the user from the dictionary storage unit in a case where the destination of the user detected by the destination detection unit is coincident with the direction detected by the sound-collecting direction detection unit.

The imaging unit may image a plurality of users, the user identification unit may identify each of the plurality of users, the voice recognition system may further comprise: a direction-of-gaze detection unit operable to detect a direction of gaze of at least one of the plurality of users based on the image captured by the imaging unit; and a speaker identification unit operable to determine one user who is gazed and recognized by the at least one user, as a speaker, and the dictionary selection unit may select a dictionary for voice recognition for the speaker identified by the speaker identification unit from the dictionary storage unit.

The speaker identification unit may determine another user who is gazed and recognized by the speaker as a next speaker.

The voice recognition system may further comprise a sound-collecting sensitivity adjustment unit operable to increase sensitivity of a microphone for collecting sounds from a direction of the speaker determined by the speaker identification unit as compared with a microphone for collecting sounds from another direction.

The voice recognition system may further comprise: a plurality of devices each of which performs an operation in accordance with a received command; a command storage unit operable to store a command to be transmitted to one of the devices and device identification information identifying the one device to which the command is to be transmitted in such a manner that the command and the device identification information are associated with each user and text data; and a command selection unit operable to select device identification information and a command that are associated with the user identified by the user identification unit and text data obtained by voice recognition by the voice recognition unit, and to transmit the selected command to a device identified by the selected device identification information.

The imaging unit may further image a movable range of the user. The voice recognition system may further include a destination detection unit operable to detect destination of the user based on the image of the user and an image of the movable range that were taken by the imaging unit. The command storage unit may store the command and the device identification information for each user and text data to be further associated with information identifying destination of the each user. The command selection unit may select the device identification information and the command that are further associated with the destination of the user detected by the destination detection unit from the command storage unit.

The voice recognition system may further comprise: a plurality of sound collectors, provided at different positions, respectively, operable to collect the voice of the user; and a user's position detection unit operable to detect a position of the user based on a phase difference between sound waves collected by the plurality of sound collectors. The imaging unit may take an image of the position detected by the user's position detection unit as the image of the user.

The imaging unit may image a plurality of users at the position detected by the user's position detection unit. The voice recognition system may further comprise a direction-of-gaze detection unit operable to detect a direction of gaze of at least one of the plurality of users based on the image captured by the imaging unit. The user identification unit may determine one user who is gazed and recognized by the at least one user, as a speaker. The dictionary selection unit may select a dictionary for voice recognition for the speaker from the dictionary storage unit.

The voice recognition system may further comprise a content identification and recording unit operable to convert the voice recognized by the voice recognition unit into content-description information that depends on the user identified by the user identification unit and describes what is meant by the voice for the user, and to record the content-description information.

According to the second aspect of the present invention, a voice recognition system comprises: a dictionary storage unit operable to store a dictionary for voice recognition for every user's attribute indicating an age group, sex or race of a user; an imaging unit operable to capture an image of a user; a user's attribute identification unit operable to identify a user's attribute of the user by using an image captured by the imaging unit; a dictionary selection unit operable to select a dictionary for voice recognition for the user's attribute identified by the user's attribute identification unit from the dictionary storage unit; and a voice recognition unit operable to recognize a voice of the user by using the dictionary for voice recognition selected by the dictionary selection unit.

The voice recognition system may further comprise a content identification and recording unit operable to convert the voice recognized by the voice recognition unit into content-description information that depends on the user's attribute identified by the user's attribute identification unit and describes what is meant by the voice for the user, and to record the content-description information.

The voice recognition system may further comprise a band-pass filter selection unit operable to select one of a plurality of band-pass filters having different frequency characteristics, that transmits the voice of the user more as compared with a voice of another user, wherein the voice recognition unit removes a noise of the voice that is to be subjected to voice recognition by the selected one band-pass filter.

According to the third aspect of the present invention, a program making a computer work as a voice recognition system, wherein the program makes the computer work as; a dictionary storage unit operable to store a dictionary for voice recognition for every user; an imaging unit operable to capture an image of a user; a user identification unit operable to identify the user by using an image captured by the imaging unit; a dictionary selection unit operable to select a dictionary for voice recognition for the user identified by the user identification unit from the dictionary storage unit; and a voice recognition unit operable to perform voice recognition for a voice of the user by using the dictionary for voice recognition selected by the dictionary selection unit.

According to the present invention, the precision of voice recognition can be improved without a troublesome operation.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 generally shows a voice recognition system 10 according to the first embodiment of the present invention.

FIG. 2 shows an exemplary data structure of a command database 185 according to the first embodiment of the present invention.

FIG. 3 is an exemplary flowchart of an operation of the voice recognition system 10 according to the first embodiment of the present invention.

FIG. 4 generally shows a voice recognition system 10 according to the second embodiment of the present invention.

FIG. 5 shows an exemplary data structure of a dictionary storage unit 365 according to the second embodiment of the present invention.

FIG. 6 shows an exemplary data structure of a content-description dictionary storage unit 375 according to the second embodiment of the present invention.

FIG. 7 is an exemplary flowchart of an operation of the voice recognition system 10 according to the second embodiment of the present invention.

FIG. 8 shows an exemplary hardware configuration of a computer 500 working as the voice recognition system 10 according to the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

(Embodiment 1)

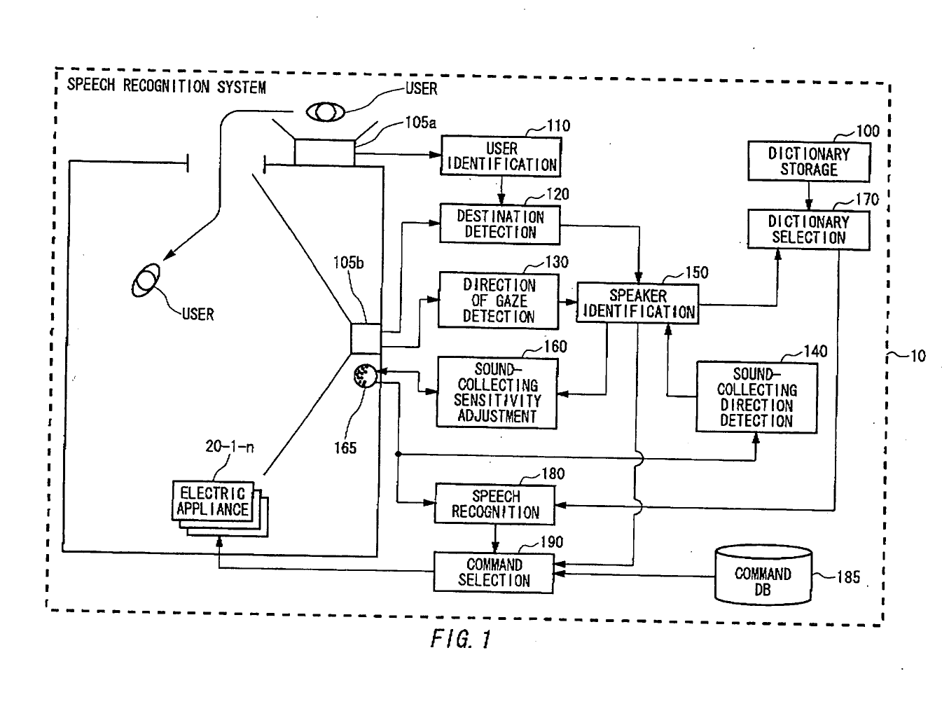

FIG. 1 generally shows a voice recognition system 10. The voice recognition system 10 includes electric appliances 20-1, . . . , 20-N that are exemplary devices recited in the claims, each of which performs an operation in accordance with a received command, a dictionary storage unit 100, imaging unit 105a, 105b, a user identification unit 110, a destination detection unit 120, a direction-of-gaze detection unit 130, a sound-collecting direction detection unit 140, a speaker identification unit 150, a sound-collecting sensitivity adjustment unit 160, a dictionary selection unit 170, a voice recognition unit 180, a command database 185 that is an exemplary command storage unit of the present invention, and a command selection unit 190.

The voice recognition system 10 aims to improve the precision of voice recognition for a voice of a user by selecting a dictionary for voice recognition that is appropriate for that user based on an image of that user. The dictionary storage unit 100 stores a dictionary for voice recognition, used for recognizing a voice and converting it into text data, for every user. For example, different dictionaries for voice recognition are stored for different users, respectively, and each of the dictionaries is set to be appropriate for recognizing the voice of the corresponding user.

The imaging unit 105a is provided at an entrance of a room and takes an image of the user who enters the room. The user identification unit 110 identifies the user by using the image captured by the imaging unit 105a. For example, the user identification unit 110 may store, for each user, information indicating a feature of a face of that user in advance and may identify that user by selecting a user whose stored feature is coincident with the feature extracted from the taken image. Moreover, the user identification unit 110 detects another feature of the identified user, that can be recognized more easily as compared with the feature of the face, such as a color of clothes of the user or the height of the user, and then transmits the detected feature to the destination detection unit 120.

The imaging unit 105b images a movable range of the user, for example, the inside of the room. Then, the destination detection unit 120 detects the destination of the user based on the image of the user taken by the imaging unit 105a and the image of the movable range taken by the imaging unit 105b. For example, the destination detection unit 120 receives information on the feature that can be recognized more easily as compared with the feature of the user's face, such as the color of the clothes or the height of the user, from the user identification unit 110. Then, the destination detection unit 120 detects a part of the image captured by the imaging unit 105b, that is coincident with the received information on the feature. In this manner, the destination detection unit 120 can detect which part in the range imaged by the imaging unit 105b is the user's destination.

The direction-of-gaze detection unit 130 detects a direction of gaze of at least one user based on the image captured by the imaging unit 105b. For example, the direction-of-gaze detection unit 130 may determine the orientation of the user's face or the position of the iris of the user's eye in the taken image so as to detect the direction of gaze.

The sound-collecting direction detection unit 140 detects a direction from which a sound collector 165 collected a voice. For example, in a case where the sound collector 165 includes a plurality of microphones having relatively high directivity, the sound-collecting direction detection unit 140 may detect a direction of the directivity of the microphone that collected the loudest sound as the direction from which the voice was collected.

In a case where the destination of the user that was detected by the destination detection unit 120 is coincident with the direction detected by the sound-collecting direction detection unit 140, the speaker identification unit 150 determines that user as a speaker. Moreover, the speaker identification unit 150 may determine one user who is gazed and recognized by at least one user, as the speaker. The sound-collecting sensitivity adjustment unit 160 sets the sound collector 165 to make the sensitivity of the microphone that collects a sound from the direction of the speaker recognized by the speaker recognition unit 150 higher, as compared with the microphone collecting a sound from a different direction.

The dictionary selection unit 170 selects a dictionary for voice recognition for the thus identified speaker from the dictionary storage unit 100 and sends the selected dictionary for voice recognition to the voice recognition unit 180. Alternatively, the dictionary selection unit 170 may acquire the dictionary for voice recognition from a server provided separately from the voice recognition system 10. Then, the voice recognition unit 180 carries out voice recognition for the voice collected by the sound collector 165 by using the dictionary for voice recognition selected by the dictionary selection unit 170, thereby converting the voice into text data.

The command database 185 stores a command to be transmitted to any one of the electric appliances 20-1, . . . 20-N and electric appliance identification information identifying the electric appliance to which that command is to be transmitted in such a manner that the command and the electric appliance identification information are associated with a user, text data and the destination of that user. The command selection unit 190 selects the command and the electric appliance identification information that are associated with the speaker identified by the user identification unit 110 and the speaker identification unit 150, the destination of the speaker detected by the destination detection unit 120 and the text data obtained by voice recognition by the voice recognition unit 180, from the command database 185. The command selection unit 190 then transmits the selected command to the electric appliance identified by the selected electric appliance identification information, for example, the electric appliance 20-1.

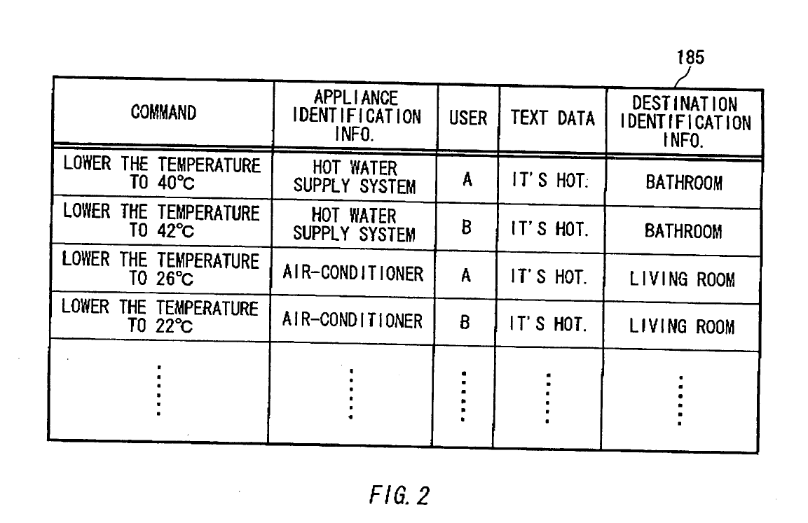

FIG. 2 shows an exemplary data structure of the command database 185. The command database 185 stores a command to be transmitted to any one of the electric appliances 20-1, . . . 20-N and electric appliance identification information identifying the electric appliance to which that command is to be transmitted in such a manner that they are associated with a user, text data and destination identification information identifying the destination of that user.

For example, the command database 185 stores a command for lowering the temperature of hot water in a bathtub to 40° C. and a hot water supply system to which that command is to be transmitted so as to be associated with User A, “It's hot”, and a bathroom. The command database 185 also stores a command for lowering the temperature of hot water in the bathtub to 42° C. and the hot water supply system to which that command is to be transmitted so as to be associated with User B, “It's hot”, and the bathroom. Thus, when User A said in the bathroom, “It's hot”, the command selection unit 190 transmits the command for lowering the temperature of hot water in the bathtub to 40° C. to the hot water supply system. When User B said in the bathroom, “It's hot”, the command selection unit 190 transmits the command for lowering the temperature of hot water in the bathtub to 42° C. to the hot water supply system.

In this manner, by storing the same text data to be associated with different commands for different users in the command database 185, the command selection unit 190 can execute the command satisfying the user's expectation.

The command database 185 stores a command for lowering the room temperature to 26° C. and an air-conditioner to which that command is to be transmitted so as to be associated with User A, “It's hot” and a living room. Thus, the command selection unit 190 transmits the command for lowering the room temperature to 26° C. to the air-conditioner when User A said in the living room, “It's hot”, and transmits the command for lowering the temperature of the hot water to 40° C. to the hot water supply system when User A said in the bathroom, “It's hot”.

Moreover, the command database 185 stores a command for lowering the room temperature to 22° C. and the air-conditioner to which that command is to be transmitted so as to be associated with User B, “It's hot” and the living room. Thus, the command selection unit 190 transmits the command for lowering the room temperature to 22° C. to the air-conditioner when User B said in the living room, “It's hot”, and transmits the command for lowering the temperature of the hot water to 42° C. to the hot water supply system when User B said in the bathroom, “It's hot”.

In this manner, since the command database 185 stores the same text data so as to be associated with different electric appliances depending on the destination of the user, the command selection unit 190 can make the electric appliance that satisfies the user's expectation execute the command.

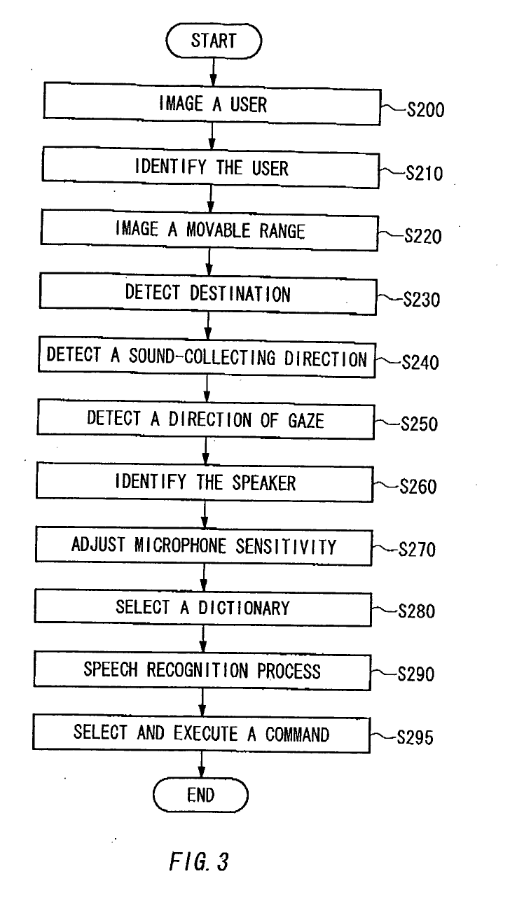

FIG. 3 is an exemplary flowchart of an operation of the voice recognition system 10. The imaging unit 105a images a user who enters a room (Step S200). The user identification unit 110 identifies the user by using an image captured by the imaging unit 105a (Step S210). The imaging unit 105b images a range within which the user can move, for example, the inside of that room (Step 5220). The destination detection unit 120 detects the destination of the user based on the image of the user taken by the imaging unit 105a and the image of the movable range taken by the imaging unit 105b (Step S230).

The sound-collecting direction detection unit 140 detects a direction from which the sound collector 165 collected a voice (Step S240). In a case where the sound collector 165 includes a plurality of microphones having relatively high directivity, the sound-collecting direction detection unit 140 may detect a direction of the directivity of the microphone that collected the loudest sound as the direction from which the voice was collected.

The direction-of-gaze detection unit 130 detects a direction of gaze of at least one user based on the image captured by the imaging unit 105b (Step S250). For example, the direction-of-gaze detection unit 130 may detect the direction of gaze by determining the orientation of the user's face or the position of the iris of the user's eye in the taken image.

Then, in a case where the destination of the user detected by the destination detection unit 120 is coincident with the sound-collecting direction detected by the sound-collecting direction detection unit 140, the speaker identification unit 150 determines that that user is a speaker (Step S260). Moreover, the speaker identification unit 150 may determine one user who is gazed and recognized by at least one user, as the speaker. More specifically, the speaker identification unit 150 may identify one user who is gazed and recognized by the speaker, as the next speaker.

The speaker identification unit 150 may identify the speaker by combining the above two determination methods. For example, in a case where the sound-colleting direction detected by the sound-collecting direction detection unit 140 is not coincident with the destination of any user, the speaker identification unit 150 may determine one user who is gazed and recognized by another user, as the speaker.

The sound-collecting sensitivity adjustment unit 160 increases the sensitivity of the microphone that collects a sound from the direction of the speaker identified by the speaker identification unit 150, as compared with the sensitivity of the microphone for collecting a sound from a different direction (Step S270). The dictionary selection unit 170 selects a dictionary for voice recognition for the speaker identified by the speaker identification unit 150 from the dictionary storage unit 100 (Step S280).

The voice recognition unit 180 carries out voice recognition for the voice collected by the sound collector 165 by using the selected dictionary for voice recognition, thereby converting the voice into text data (Step S290). Moreover, the voice recognition unit 180 may change the dictionary for voice recognition that was selected by the dictionary selection unit 170, based on the result of voice recognition in order to improve the precision of voice recognition.

The command selection unit 190 selects from the command database 185 a command and electric appliance identification information that are associated with the speaker identified by the user identification unit 110 and speaker identification unit 150, the destination of the speaker detected by the destination detection unit 120, and the text data obtained by voice recognition by the voice recognition unit 180. Then, the command selection unit 190 transmits the selected command to the electric appliance identified by the selected electric appliance identification information (Step S295).

(Embodiment 2)

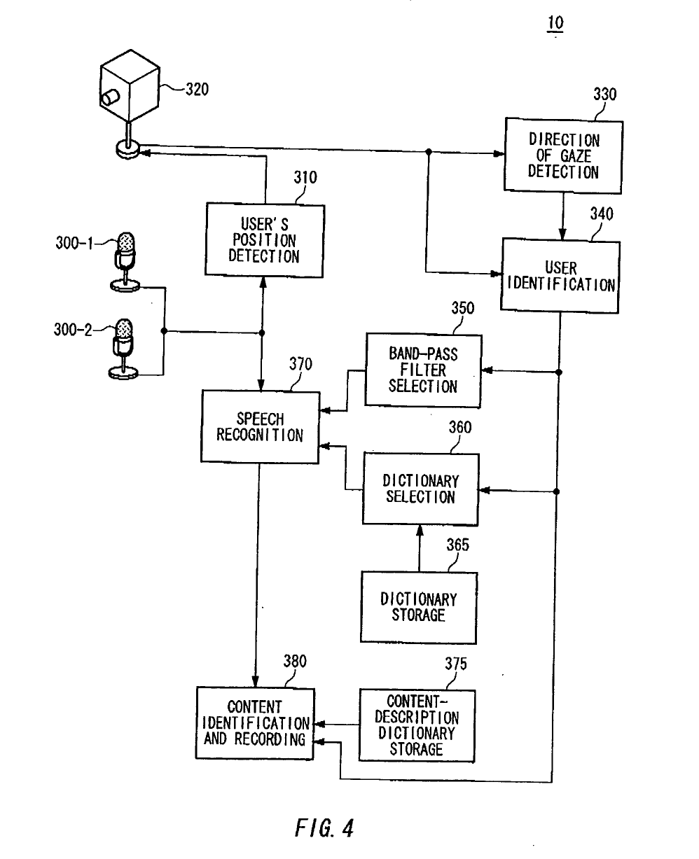

FIG. 4 generally shows the voice recognition system 10 according to the second embodiment of the present invention. In this embodiment, the voice recognition system 10 includes sound collectors 300-1 and 300-2, a user's position detection unit 310, an imaging unit 320, a direction-of-gaze detection unit 330, a user identification unit 340, a band-pass filter selection unit 350, a dictionary selection unit 360, a dictionary storage unit 365, a voice recognition unit 370, a content-description dictionary storage unit 375 and a content identification and recording unit 380. The sound collectors 300-1 and 300-2 are provided at different positions, respectively, and collect a voice of a user. The user's position detection unit 310 detects the position of the user based on a phase difference between sound waves collected by the sound collectors 300-1 and 300-2.

The imaging unit 320 takes an image of the position detected by the user's position detection unit 310, as an image of the user. In a case where the imaging unit 320 imaged a plurality of images, the direction-of-gaze detection unit 330 detects a direction of gaze of at least one user based on the image captured by the imaging unit 320. Then, the user identification unit 340 identifies one user who is gazed and recognized by at least one user, as a speaker. In this identification, the user identification unit 340 preferably identifies user's attribute indicating an age group, sex or race of the user who is the speaker.

The band-pass filter selection unit 350 selects one of a plurality of band-pass filters having different frequency characteristics, that transmits the voice of the user more as compared with other sounds, based on the user's attribute of the user. The dictionary storage unit 365 stores a dictionary for voice recognition for every user or every user's attribute. The dictionary selection unit 360 selects the dictionary for voice recognition for the user's attribute identified by the user identification unit 340 from the dictionary storage unit 365. The voice recognition unit 370 removes a noise of the voice that is subjected to voice recognition by the selected band-pass filter. The voice recognition unit 370 then recognizes the voice of the user by using the dictionary for voice recognition that was selected by the dictionary selection unit 360.

The content-description dictionary storage unit 375 stores, for every user and for the recognized voice, content-description information indicating what is meant by that recognized voice for that user so as to be associated with the recognized voice. The content identification and recording unit 380 converts the voice recognized by the voice recognition unit 370 into content-description information that depends on the user or user's attribute identified by the user identification unit 340 and indicates what is meant by that voice for that user. The content identification and recording unit 380 then records the thus obtained content-description information.

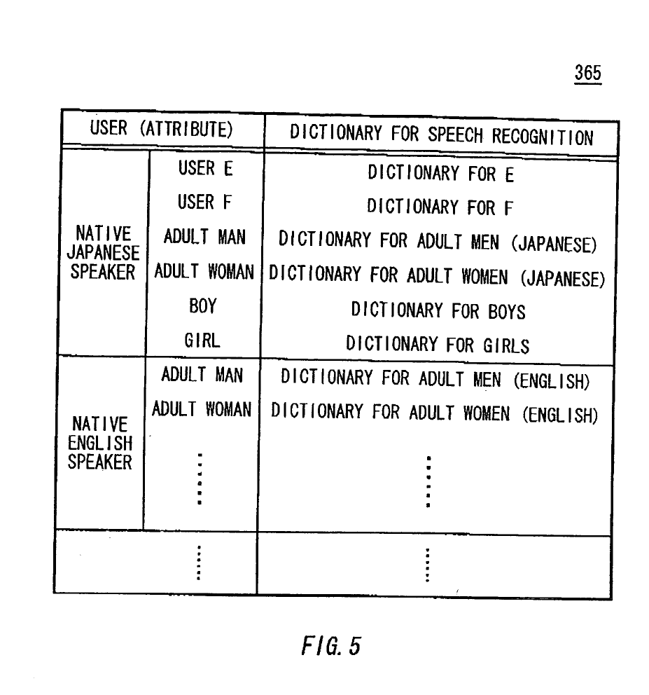

FIG. 5 shows an exemplary data structure of the dictionary storage unit 365. The dictionary storage unit 365 stores a dictionary for voice recognition for every user or every user's attribute indicating an age group, sex or race of the user. For example, the dictionary storage unit 365 stores for User E his/her own dictionary. The dictionary storage unit 365 stores a Japanese dictionary for adult men to be associated with the user's attribute indicating “adult man” and “native Japanese speaker”. Moreover, the dictionary storage unit 365 stores an English dictionary for adult men to be associated with the user's attribute indicating “adult man” and “native English speaker”.

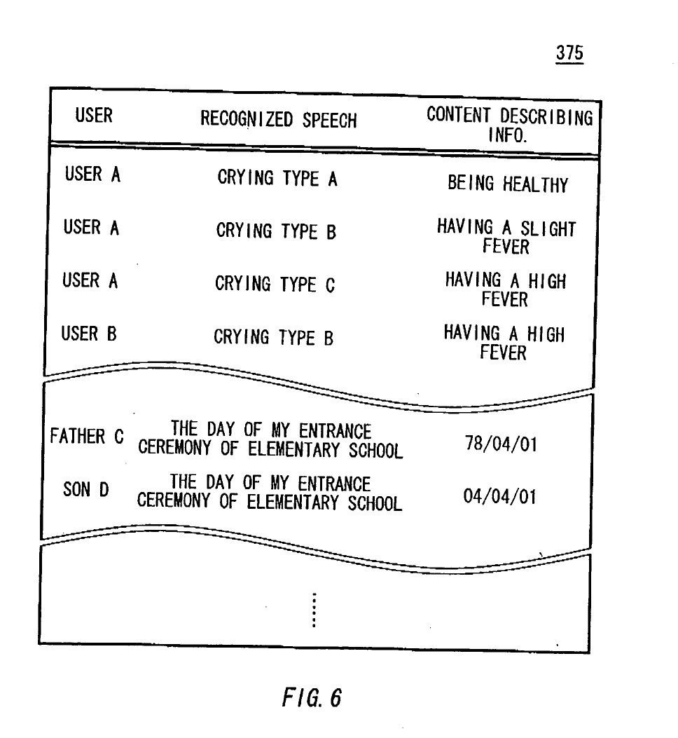

FIG. 6 shows an exemplary data structure of the content-description dictionary storage unit 375. The content-description dictionary storage unit 375 stores, for every user and for the recognized voice, content-description information describing the meaning of that recognized voice for that user. For example, the content-description dictionary storage unit 375 stores, for Baby A as the user and for Crying of Type a that corresponds to the recognized voice, content-description information describing that Baby A means that he/she is well.

Thus, in a case where the crying of Baby A was recognized to be correspond to Crying of Type a, the content identification and recording unit 380 records the content-description information describing that Baby A is well. Similarly, in a case where the crying of Baby A was recognized as Crying of Type b, the content identification and recording unit 380 records the content-description information describing that Baby A has a slight fever. Moreover, in a case where the crying of Baby A was recognized as Crying of Type c, the content identification and recording unit 380 records the content-description information describing that Baby A has a high fever. In this manner, according to the voice recognition system 10 of the present embodiment, it is possible to record a health condition of a baby by voice recognition.

On the other hand, in a case where the crying of Baby B was recognized as Crying of Type b, the content identification and recording unit 380 records the content-description information describing that Baby B has a high fever. In this manner, even in a case where the same type of voice was recognized, the content identification and recording unit 380 can record appropriate content-description information that depends on the speaker.

In addition, the content-description dictionary storage unit 375 stores, for Father C as the user and “the day of my entrance ceremony of elementary school” as the recognized voice, “78/04/01” that corresponds to the meaning of the recognized voice for Father C. The content-description dictionary storage unit 375 also stores, for Son D as the user and “the day of my entrance ceremony of elementary school” as the recognized voice, “Apr. 4, 2001” that corresponds to the meaning of the recognized voice for Son D. In other words, by using the image of the speaker, it is possible to record not only the voice that was recognized but also the meaning of that voice.

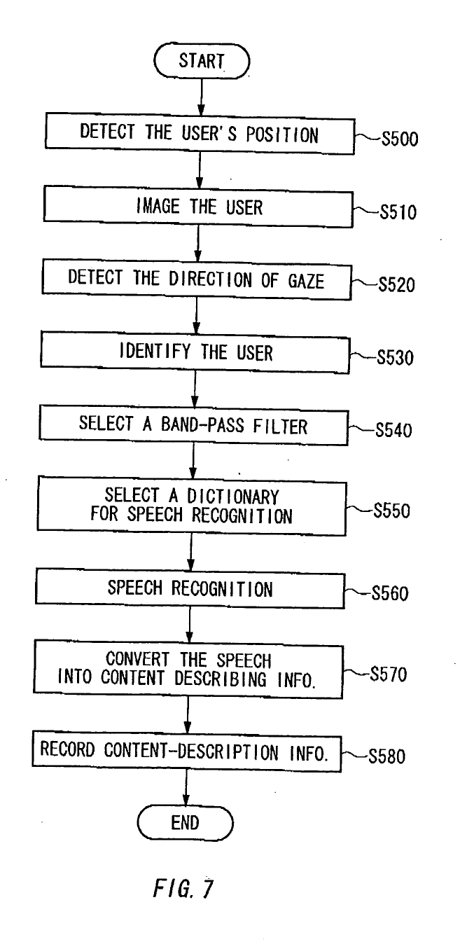

FIG. 7 is an exemplary flowchart of an operation of the voice recognition system 10. The user's position detection unit 310 detects the position of the user based on a phase difference between sound waves collected by the sound collectors 300-1 and 300-2 (Step S500). The imaging unit 320 takes an image of the position detected by the user's position detection unit 310 as a user's image (Step S510). In a case where a plurality of users were imaged, the direction-of-gaze detection unit 330 detects a direction of gaze of at least one user based on the image captured by the imaging unit 320 (Step S520).

Then, the user identification unit 340 identifies one user who is gazed and recognized by the at least one user, as a speaker (Step S530). In this identification, the user identification unit 340 preferably identifies the user's attribute indicating the age group, sex or race of the user who is the speaker. The band-pass filter selection unit 350 selects one of a plurality of band-pass filters having different frequency characteristics, respectively, that transmits the voice of the user more as compared with other sounds, in accordance with the user's attribute of that user (Step S540).

The dictionary selection unit 360 selects the dictionary for voice recognition that is associated with the user's attribute identified by the user identification unit 340 (Step S550). The voice recognition unit 370 removes a noise of the voice that is subjected to voice recognition with the selected band-pass filter, and performs voice recognition for the voice of the user by using the dictionary for voice recognition selected by the dictionary selection unit 360 (Step S560). The content identification and recording unit 380 converts the recognized voice into content-description information describing the meaning of that voice for that user (Step S570) and records the content-description information (Step S580).

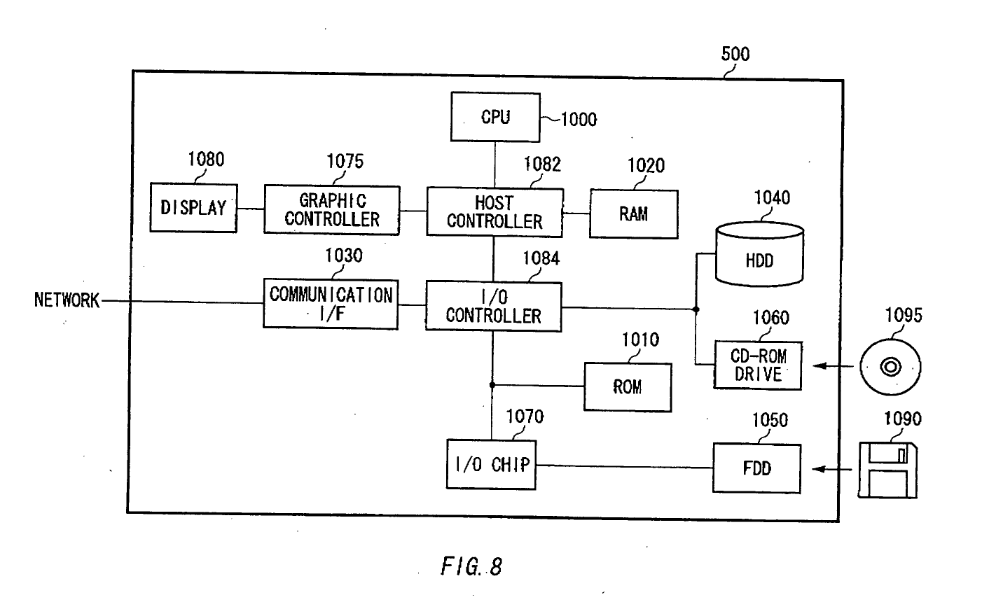

FIG. 8 shows an exemplary hardware configuration of a computer 500 that works as the voice recognition system 10 in the first or second embodiment. The computer 500 includes a CPU peripheral part, an input/output part and a legacy input/output part. The CPU peripheral part includes a CPU 1000, a RAM 1020, a graphic controller 1075 that are connected to each other by a host controller 1082, and a display 1080. The input/output part includes a communication interface 1030, a hard disk drive 1040 and a CD-ROM drive 1060 that are connected to the host controller 1082 by an input/output (I/O) controller 1084. The legacy input/output part includes a ROM 1010, a flexible disk drive 1050 and an input/output (I/O) chip 1070 that are connected to the I/O controller 1084. Please note that the hard disk drive 1040 is not necessary. The hard disk drive 1040 may be replaced with a nonvolatile flash memory.

The host controller 1082 connects the RAM 1020 to the CPU 1000 for making an access to the RAM 1020 at a high transfer rate and the graphic controller 1075 to each other. The CPU 1000 operates based on a program stored in the RAM 1010 and the RAM 1020, so as to control the respective components. The graphic controller 1075 acquires image data generated by the CPU 1000 or the like on a frame buffer provided in the RAM 1020 and makes the display 1080 display an image. Alternatively, the graphic controller 1075 may include a frame buffer for storing the image data generated by the CPU 1000 or the like, therein.

The I/O controller 1084 connects the communication interface 1030, the hard disk drive 1040 and the CD-ROM drive 1060 that are relatively high-speed input/output devices, and the host controller 1082. The communication interface 1030 communicates with a device in the outside of the computer 500 via a network such as a fiber channel. The hard disk drive 1040 stores a program and data used by the computer 500. The CD-ROM drive 1060 reads a program or data from a CD-ROM 1095 and provides the read program or data to the I/O chip 1070 via the RAM 1020.

Moreover, to the I/O controller 1084 is connected the ROM 1010 and relatively low-speed input/output devices, such as the flexible disk drive 1050 and the I/O chip 1070. The ROM 1010 stores a boot program that is executed by the CPU 1000 at the startup of the computer 500, a program depending on the hardware of the computer 500, and the like. The flexible disk drive 1050 reads a program or data from a flexible disk 1090 and provides the read program or data to the I/O chip 1070 via the RAM 1020. The I/O chip 1070 connects the flexible disk 1090 and various input/output devices via a parallel port, a serial port, a keyboard port, a mouse port and the like.

The program provided to the computer 500 is provided by the user while being stored in a recording medium such as a flexible disk 1090, a CD-ROM 1095 or an IC card. The program is readout from the recording medium via the I/O chip 1070 and/or the I/O controller 1084 and is then installed into and executed by the computer 500.

The program that makes the computer 500 work as the voice recognition system 10 when being installed into and executed by the computer 500, includes an imaging module, a user identification module, a destination detection module, a direction-of-gaze detection module, a sound-collecting direction detection module, a dictionary selection module, a voice recognition module and a command selection module. The program may use the hard disk drive 1040 as the dictionary storage unit 100 or the command database 1085. Operations of the computer 500 that are performed by actions of the respective modules are the same as the operations of the corresponding components of the voice recognition system 10 described referring to FIGS. 1 and 3, and therefore the description of those operations is omitted.

The aforementioned program or module may be stored in an external recording medium. As the recording medium, other than the flexible disk 1090 and the CD-ROM 1095, an optical recording medium such as a DVD or PD, a magneto-optical disk such as an MD, a tape-like medium, a semiconductor memory such as an IC card may be used, for example. Moreover, a storage device such as a hard disk or RAM provided in a server system connected to an exclusive communication network or the Internet may be used as the recording medium so as to provide the program to the computer 500 through the network.

As described above, the voice recognition system 10 uses the dictionary for voice recognition that is appropriate for the user depending on the user based on the image of the user, thereby improving the precision of voice recognition. Thus, even in a case of changing the user, it is not necessary to perform a troublesome operation for changing the dictionary. Therefore, the voice recognition system 10 of the present invention is convenient. Moreover, the voice recognition system 10 detects the speaker based on the direction from which the voice was collected or the direction of gaze of the user. Thus, even in a case where there are a plurality of users, it is possible to change the dictionary for voice recognition to another dictionary that is appropriate for the speaker every time the speaker was changed.

In the aforementioned embodiments, the voice recognition system 10 is a device for operating the electric appliances 20-1, . . . , 20-N. However, the voice recognition system of the present invention is not limited thereto. For example, the voice recognition system 10 may be a system for recording text data obtained by conversion of the voice of the user in a recording device or displaying such text data on a display screen.

Although the present invention has been described by way of exemplary embodiments, it should be understood that those skilled in the art might make many changes and substitutions without departing from the spirit and the scope of the present invention which is defined only by the appended claims.

1. A voice recognition system comprising:
a dictionary storage unit operable to store a dictionary for voice recognition for every user;
an imaging unit operable to capture an image of a user;
a user identification unit operable to identify said user by using an image captured by said imaging unit;
a dictionary selection unit operable to select a dictionary for voice recognition for said user identified by said user identification unit from said dictionary storage unit; and
a voice recognition unit operable to perform voice recognition for a voice of said user by using said dictionary for voice recognition selected by said dictionary selection unit.

2. A voice recognition system as claimed in claim 1, wherein said imaging unit further images a movable range of said user,
said voice recognition system further comprises:
a destination detection unit operable to detect destination of said user based on said image of said user and an image of said movable range that were taken by said imaging unit; and
a sound-collecting direction detection unit operable to detect a direction from which said voice was collected, and
said dictionary selection unit selects said dictionary for voice recognition for said user from said dictionary storage unit in a case where said destination of said user detected by said destination detection unit is coincident with said direction detected by said sound-collecting direction detection unit.

3. A voice recognition system as claimed in claim 1, wherein said imaging unit images a plurality of users,
said user identification unit identifies each of said plurality of users,
said voice recognition system further comprises:
a direction-of-gaze detection unit operable to detect a direction of gaze of at least one of said plurality of users based on said image captured by said imaging unit; and
a speaker identification unit operable to determine one user who is gazed and recognized by said at least one user, as a speaker, and
said dictionary selection unit selects a dictionary for voice recognition for said speaker identified by said speaker identification unit from said dictionary storage unit.

4. A voice recognition system as claimed in claim 3, wherein said speaker identification unit determines another user who is gazed and recognized by said speaker as a next speaker.

5. A voice recognition system as claimed in claim 3, further comprising a sound-collecting sensitivity adjustment unit operable to increase sensitivity of a microphone for collecting sounds from a direction of said speaker determined by said speaker identification unit as compared with a microphone for collecting sounds from another direction.

6. A voice recognition system as claimed in claim 1 further comprising:
a plurality of devices each of which performs an operation in accordance with a received command;
a command storage unit operable to store a command to be transmitted to one of said devices and device identification information identifying said one device to which said command is to be transmitted in such a manner that said command and said device identification information are associated with each user and text data; and
a command selection unit operable to select device identification information and a command that are associated with said user identified by said user identification unit and text data obtained by voice recognition by said voice recognition unit, and to transmit said selected command to a device identified by said selected device identification information.

7. A voice recognition system as claimed in claim 6, wherein said imaging unit further images a movable range of said users
said voice recognition system further includes a destination detection unit operable to detect destination of said user based on said image of said user and an image of said movable range that were taken by said imaging unit,
said command storage unit stores said command and said device identification information for each user and text data to be further associated with information identifying destination of said each user,
said command selection unit selects said device identification information and said command that are further associated with said destination of said user detected by said destination detection unit from said command storage unit.

8. A voice recognition system as claimed in claim 1, further comprising:
a plurality of sound collectors, provided at different positions, respectively, operable to collect said voice of said user; and
a user's position detection unit operable to detect a position of said user based on a phase difference between sound waves collected by said plurality of sound collectors, and
said imaging unit takes an image of said position detected by said user's position detection unit as said image of said user.

9. A voice recognition system as claimed in claim 8, wherein said imaging unit images a plurality of users at said position detected by said user's position detection unit,
said voice recognition system further comprises a direction-of-gaze detection unit operable to detect a direction of gaze of at least one of said plurality of users based on said image captured by said imaging unit,
said user identification unit determines one user who is gazed and recognized by said at least one user, as a speaker, and
said dictionary selection unit selects a dictionary for voice recognition for said speaker from said dictionary storage unit.

10. A voice recognition system as claimed in claim 1, further comprising a content identification and recording unit operable to convert said voice recognized by said voice recognition unit into content-description information that depends on said user identified by said user identification unit and describes what is meant by said voice for said user, and to record said content-description information.

11. A voice recognition system comprises:
a dictionary storage unit operable to store a dictionary for voice recognition for every user's attribute indicating an age group, sex or race of a user;
an imaging unit operable to capture an image of a user;
a user's attribute identification unit operable to identify a user's attribute of said user by using an image captured by said imaging unit;
a dictionary selection unit operable to select a dictionary for voice recognition for said user's attribute identified by said user's attribute identification unit from said dictionary storage unit; and
a voice recognition unit operable to recognize a voice of said user by using said dictionary for voice recognition selected by said dictionary selection unit.

12. A voice recognition system as claimed in claim 11, further comprising a content identification and recording unit operable to convert said voice recognized by said voice recognition unit into content-description information that depends on said user's attribute identified by said user's attribute identification unit and describes what is meant by said voice for said user, and to record said content-description information.

13. A voice recognition system as claimed in claim 11, further comprising a band-pass filter selection unit operable to select one of a plurality of band-pass filters having different frequency characteristics, that transmits said voice of said user more as compared with a voice of another user, wherein
said voice recognition unit removes a noise of said voice that is to be subjected to voice recognition by said selected one band-pass filter.

14. A program making a computer work as a voice recognition system, wherein said program makes said computer work as:
a dictionary storage unit operable to store a dictionary for voice recognition for every user;
an imaging unit operable to capture an image of a user;
a user identification unit operable to identify said user by using an image captured by said imaging unit;
a dictionary selection unit operable to select a dictionary for voice recognition for said user identified by said user identification unit from said dictionary storage unit; and
a voice recognition unit operable to perform voice recognition for a voice of said user by using said dictionary for voice recognition selected by said dictionary selection unit.
